(19) United States
(12) Patent Application Publication
(10) Pub. No.: US 2007/0158278 A1
(43) Pub. Date: Jul. 12, 2007

(54) Sand filter cleaning apparatus and method thereof

(76) Inventor: Denis Deschenes, Le Gardeur (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 11/327,513

(22) Filed: Jan. 9, 2006

(51) Int. Cl. B01D 24/46

(52) U.S. Cl. 210/793; 210/275

(57) ABSTRACT

An apparatus for cleaning and/or sterilizing sand filter is provided. The apparatus comprises at least one sand filter but preferably a plurality. The apparatus comprises a clean water pipe circuit and a backwash water pipe circuit. Preferably connected to the backwash water pipe circuit is a cleaning and/or sterilizing means provider. On a regular basis and/or when it is detected that the efficiency of the filter has decreased below a certain threshold, cleaning and/or sterilizing means are added to the backwash water in order to remove unwanted particles, bacteria, oils and/or greases, metal deposits and the like that previous simple backwashes failed to remove. A method for using the apparatus thereof is also provided.

### FIELD OF THE INVENTION

The present invention relates to an apparatus and method to clean water filters. More particularly, the current invention relates to an apparatus and method to clean and/or sterilize sand filters.

### BACKGROUND OF THE INVENTION

The concept of filtering water with sand is as old as planet earth. Naturally occurring sand barriers have been filtering water for millions of years. Mankind has then rediscovered that when water containing suspended matter goes through a sand barrier, a substantial amount of the suspended matter remains in the sand barrier, thus leaving relatively filtered water on the other side of the sand barrier.

Obviously, the first artificial sand filters were using coarse sand and thus, were efficient only to a certain level. However, as the years went by, the technology behind the sand filters improved, the sand used became more and more fine and the filtration power of sand filters became greater.

Thus, nowadays, sand filters are used in numerous applications where filtered water is need. Swimming pools are now, for the vast majority, equipped with sand filters. Sand filters are also used to purify water stored in water towers and water-based heating and cooling systems. Sand filters are even used by city waste water treatment facilities.

The main idea behind a sand filter is to force water through a sand barrier. The unwanted particles contained in the water are blocked by the fine grains of sand and the water that exits the filter is more or less filtered according to the quality and efficiency of the filter. However, as time passes, more and more unwanted particles and pollutants in the form of bacteria, suspended matter, metal particles, oil/grease and the like remain stuck in the sand filter. Thus, as the filter becomes clogged with pollutants and other unwanted particles, its filtration power decreases.

In order to clean the filter from these pollutants and other particles, the usual method was to backwash the filter using an alternate water circuit. When the filter is backwashed, water is forced through the filter in the reverse direction with respect to the normal flow of the water in the filter. Contaminants stuck in the sand filter are forcefully expelled from the filter and drained away, thus leaving in the process a more or less clean filter.

Nevertheless, even if most of the particles stuck in the filter are washed away with the backwashing water, backwashing sand filter does not remove all the remaining particles, particularly heavy metal particles, bacteria and oils.

Since metal particles are usually heavier than the sand grains, they tend to sink in the filter as time goes by. When the filter is backwashed, the pressure of the water is not high enough to expel all the metal particles. Using higher pressure is not a solution since it would expel more sand than metal particles, which is not the desired result. The consequence is that over time, the filter contains more and more metals particles which, in the end, affect the filtering efficiency of the filter.

Bacteria, on the other hand, are usually lighter than sand grains. However, bacteria secrete a sticky substance called polysaccharide. This substance allows the bacteria to attach themselves to the grains of sand. As bacteria grow, they create preferential channels into the sand filter through which larger particles can easily flow. This reduces the efficiency of the filter since larger particles can now go through the filter which was previously able to block them.

Backwashing does remove a portion of the bacteria but it cannot remove them all since some of them are substantially fixedly attached to the filtering medium. Therefore, overtime, the bacteria living in the sand filter and the preferential channels they create decrease the filter efficiency.

As for oils and greases, they tend to stick to the grains of sand which are then difficult to wash with simple backwashes.

Generally, when it is detected that the efficiency of a sand filter has decreased below a minimum threshold and that backwashing is of no avail, the filtering medium of the filter is usually removed and replaced by new sand. This procedure is not only relatively long, it is also expensive.

Apparatuses and methods also exist to clean the sand of sand filter but they usually imply the physical removing of at least a portion of the sand from the filter and the installation of a separate complex sand cleaner apparatus for cleaning the removed sand (see for example U.S. Pat. Nos. 5,019,278 and 6,306,309). Furthermore, these systems add significant cost to the filter system.

There is therefore a need for an apparatus and method which will allow the simple cleaning and/or sterilizing of sand filters.

### OBJECTS OF THE INVENTION

An object of the present invention is to provide an apparatus and method which allow for the cleaning and/or sterilizing of sand filters.

Another object of the present invention is to provide an apparatus and method which will reduce the need to replace the sand medium in sand filters.

Yet another object of the present invention is to provide an apparatus and method for cleaning and/or sterilizing sand filters in a simple manner.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

### SUMMARY OF THE INVENTION

To attain these and other objects which will become more apparent as the description proceeds according to one aspect of the present invention, there is provided a sand filter cleaning apparatus and method.

The sand filter cleaning apparatus according to the present invention generally comprises at least one but preferably a plurality of sand filters. The apparatus also generally comprises a cleaning water storage tank and at least one cleaning agent provider. Depending on the nature of the pollutants filtered by the filters, more cleaning agent providers could be added to the apparatus. The apparatus also generally comprises raw water pipes, filtered water pipes, backwashing pipes, cleaning pipes and all the valves necessary to efficiently control the diverse flows of water.

According to a first aspect of the present invention, the cleaning agent provider is fluidly connected to the cleaning water storage tank via the cleaning pipes. The cleaning pipes are also fluidly connected to the outlet of the sand filter or filters via the backwashing pipes. Thus, when a mere backwash is necessary, no cleaning agent is added to the cleaning water. However, when it is detected that the filter or filters need to be cleaned, cleaning agent is added to the cleaning water. The cleaning water containing the cleaning agent enters the sand filter via the same pipes as for the backwash.

According to one aspect of the present invention, the cleaning agent is a physical cleaning agent such as heat.

According to another aspect of the present invention, the cleaning agent is a chemical cleaning agent such as but not limited to oxidizers (for example ozone, chlorine or sodium hypochlorite), oil/grease emulsifier, acids, etc. and/or combinations thereof.

According to yet another aspect, the apparatus further comprises a central controller which controls the different modes of operation of the apparatus. The apparatus is thus preferably fully automated.

A method to clean sand filters according to the present invention comprises the following steps:
providing cleaning water;
providing at least one cleaning agent;
adding the cleaning agent to the cleaning water;
circulating the cleaning water in the filter with the cleaning water containing the cleaning agent while recirculating the cleaning water for a predetermined amount of time.

In an alternate version of the precedent method, the cleaning of the filter is preceded by a normal backwash procedure wherein the backwashing water is disposed with. The alternate method would thus comprise the steps of:
providing backwashing water;
backwashing the filter with the backwashing water and disposing of the backwashing water;
providing cleaning water;
providing at least one cleaning agent;
adding the cleaning agent to the cleaning water;
circulating the cleaning water in the filter with the cleaning water containing the cleaning agent while recirculating the cleaning water for a predetermined amount of time.

It might also be preferable to purge to the pipes and the storage tank after a cleaning/sterilizing procedure in order to remove any pollutants that might remain in the pipes or tank.

In yet another aspect of the present invention, the apparatus comprises a sand filter, raw water pipes, clean water pipes, backwashing pipes, cleaning pipes and cleaning agent providing means. However, contrary to the previous embodiment, in this alternate version of the present invention, the cleaning pipes are not connected to the backwashing pipes but to the raw water pipes. Accordingly, when the filter is cleaned, the cleaning water flows in the same direction as the raw water.

A method to clean a sand filter according to this alternate apparatus would comprises the following steps:
providing cleaning water;
providing at least one cleaning agent;
adding the cleaning agent to the cleaning water;
washing the filter with the cleaning water containing the cleaning agent while recirculating said water for a predetermined amount of time.

Other aspects and many of the attendant advantages will be more readily appreciated as the same becomes better understood by reference to the following detailed description and considered in connection with the accompanying drawings in which like reference symbols designated like elements throughout the figures.

The features of the present invention which are believed to be novel are set forth with particularity in the appended claims.

### BRIEF DESCRIPTION OF THE FIGURES

FIG. 1 is a schematic view of a first embodiment of the apparatus of the present invention in filtration mode which uses heat as cleaning/sterilizing means.

FIG. 2 is a schematic view of a first embodiment of the apparatus of the present invention in filtration/backwash mode which uses heat as cleaning/sterilizing means.

FIG. 3 is a schematic view of a first embodiment of the apparatus of the present invention in filtration/rinse mode which uses heat as cleaning/sterilizing means.

FIG. 4 is a schematic view of a first embodiment of the apparatus of the present invention in filtration/sterilization mode which uses heat as cleaning/sterilizing means.

FIG. 5 is a schematic view of a first embodiment of the apparatus of the present invention in filtration/sterilization mode which uses chemicals as cleaning/sterilizing means.

FIG. 6 is a schematic view of a second embodiment of the apparatus of the present invention which uses chemical additives as cleaning/sterilizing means.

FIG. 7 is a schematic view of a third embodiment of the apparatus of the present invention in filtration mode.

FIG. 8 is a schematic view of a third embodiment of the apparatus of the present invention in backwashing mode.

FIG. 9 is a schematic view of a third embodiment of the apparatus of the present invention in rinsing mode.

FIG. 10 is a schematic view of a third embodiment of the apparatus of the present invention in cleaning/sterilization mode.

### DETAILED DESCRIPTION OF THE PREFERRED EMBODIMENTS

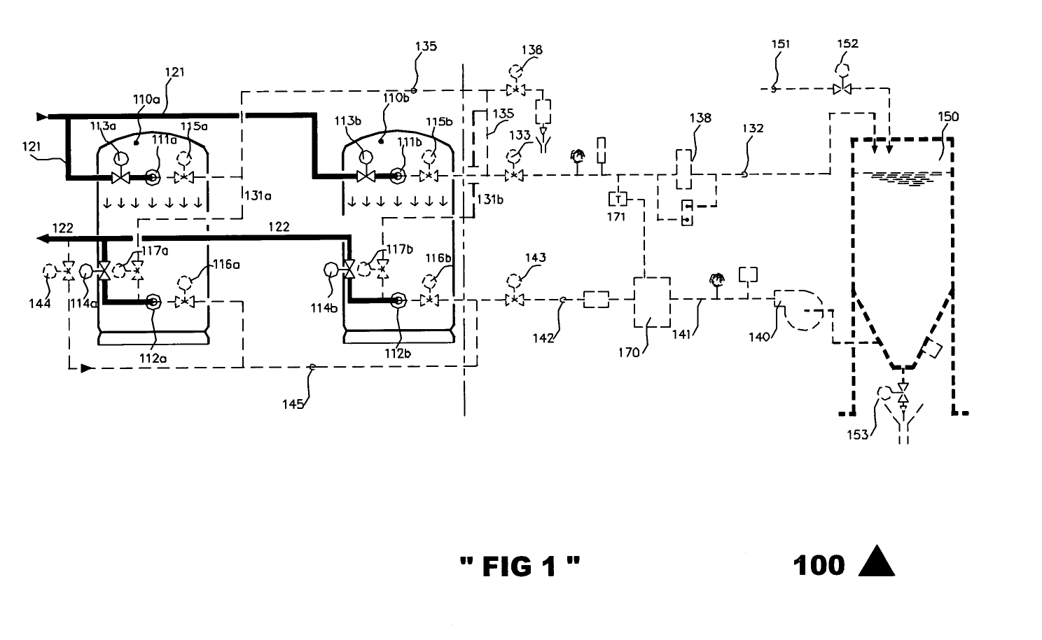

Referring to FIGS. 1 to 4, we can see a schematic view of a first preferred embodiment of the apparatus of the present invention. For the sake of clarity, each figure shows a different mode of operation of the apparatus. Therefore, to enhance the understanding of the description, in any given mode, pipes and/or equipments shown in dotted lines are generally not in use and valves shown in dotted line are generally closed. Also, in any given mode, pipes shown in bold lines are generally carrying water.

In a nutshell, in FIGS. 1 to 4, the apparatus 100 comprises two identical sand filters 110aand 110b. For the sake of simplicity, only filter 110b will be described in details albeit it is to be understood that filter 110a possesses the same components. Filter 110b has an inlet 111b and an outlet 112b which are connected to a filtered water pipe circuit and to a cleaning water pipe circuit. The apparatus further comprises a filtered water tank 150 for storing cleaning water and heating means 170 for heating the cleaning water used to clean and/or sterilize the sand filters. It is to be understood that the apparatus 100 of FIGS. 1 to 4 can be extended to more than two filters 110a and 110b. The apparatus 100 also comprises all the necessary valves and equipments to control the flow of water in the various pipes.

The apparatus 100 of FIGS. 1 to 4 allows the different modes of operation which will now be described in more details. For simplicity purpose, the following description will only refer to sand filter 110b.

Filtration mode

Now referring to FIG. 1, the filtration mode is the normal mode of operation of the apparatus 100. During this mode, raw water enters filter 110b via raw water pipe 121, valve 113b and inlet 111b. Obviously, valve 113b is open during filtration mode. The raw water is then filtered by the sand contained in sand filter 110b. Filtered water then exits filter 110b via outlet 112b. The filtered water-then exits the apparatus via valve 114b and clean water pipes 122. Valve 114b is also open during filtration mode.

Valves 115b, 116b and 117b are, for their part, closed during filtration mode. For the remainder of the present application, the valves which are not expressly identified in a given mode are presumed to be closed unless otherwise specified.

Backwashing mode

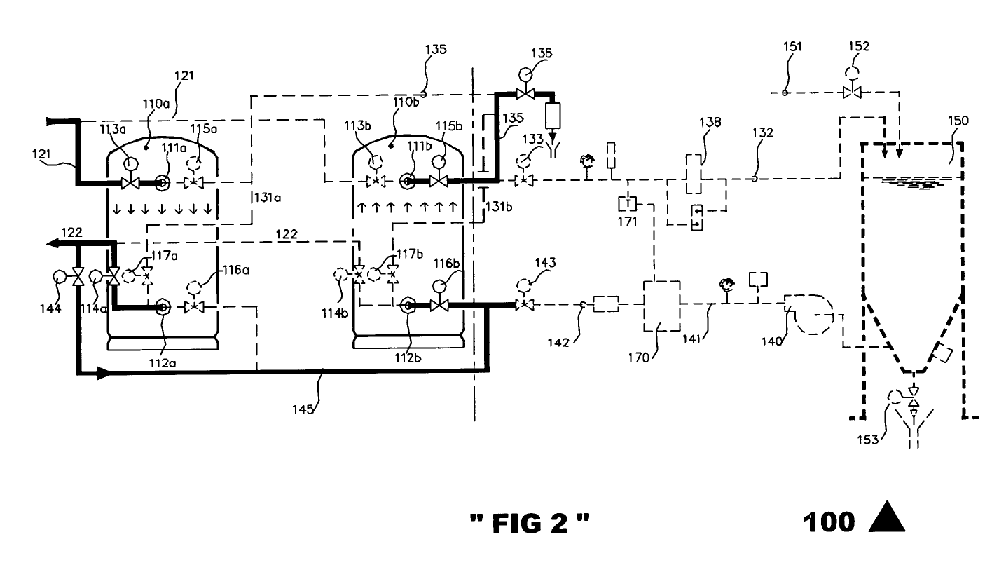

Now referring to FIG. 2, to prevent the clogging of the sand filters 110a and 110b, regular backwashes are needed to remove a substantial portion of the unwanted particles, minerals, bacteria and oils/greases which have accumulated over time in the sand filter. To do so, a portion of the water filtered by one filter is used to backwash the other filter. For example, during a backwashing cycle, a portion of the filtered water, exiting filter 110a via outlet 112a, valve 114a and clean water pipe 122, is diverted via valve 144 and pipe 145 and valve 116b to the outlet 112b of the filter 110b.

By moving backward from the normal direction of the water flow, the backwashing water removes and forcefully expels a portion of the unwanted particles, minerals, bacteria and oils present in the sand. The backwashing water, now containing unwanted particles, minerals, bacteria and/or oils, then exits the sand filter 110b via its inlet 111b and is drained away via valve 115b, draining pipes 135 and valve 136.

In a less preferred variant of the backwashing mode (not shown), clean water stored in the water tank 150 is pumped through cleaning piping 141 and 142 with the use of pump 140. During the backwashing procedure, the clean water from the tank 150 is force through the outlet 112b of the filter 110b via valves 143 and 116b. By moving backward from the normal direction of the water flow, the backwashing water removes and forcefully expels a portion of the unwanted particles, minerals, bacteria and oils present in the sand. The backwashing water, now containing unwanted particles, minerals, bacteria and/or oils, then exits the sand filter 110b via its inlet 111b and is drained away via valve 115b, draining pipes 135 and valve 136.

The valves of apparatus 100 allows for one filter to be in filtration mode while the other is in backwashing mode without interference between the various flows of water.

Rinsing mode

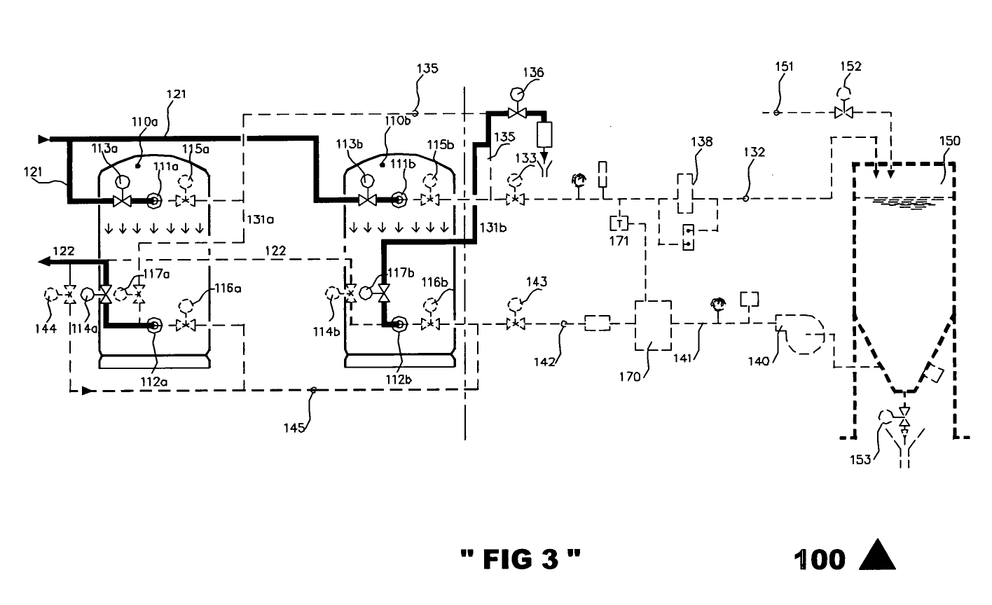

Now referring to FIG. 3, when a backwash cycle is completed, the sand medium contained in sand filter 110b may not be settled. Moreover, a portion of the dislodged pollutants might still be present in the sand. Thus, it is preferable that a backwash cycle be followed by a rinse cycle.

In a rinse cycle, raw water is entering filter 110b via pipe 121, valve 113b and inlet 111b. The raw water then goes through the sand of the sand filter 110b, effectively dragging and compacting the sand medium to its normal filtering position. At the same time, the raw water will carry away at least a portion of the dislodged pollutants still present in the filter 110b.

The water will then exit sand filter 110b via its outlet 112b. However, since the sand of the sand filter 110b was not in its normal position, the filtered water might still carry pollutants. For this reason, filtered water exiting sand filter 110b in rinsing mode will be drained away instead of being sent through the clean water pipes. Hence, water exiting outlet 112b of filter 110b in rinsing mode will be directed toward the drain via valve 117b, pipes 131b and 135 and valve 136.

After a predetermined amount of time, the filter 110b in rinsing mode will preferably automatically revert to the filtration mode. This will be done by closing valve 117b and opening valve 114b.

Cleaning/Sterilizing mode

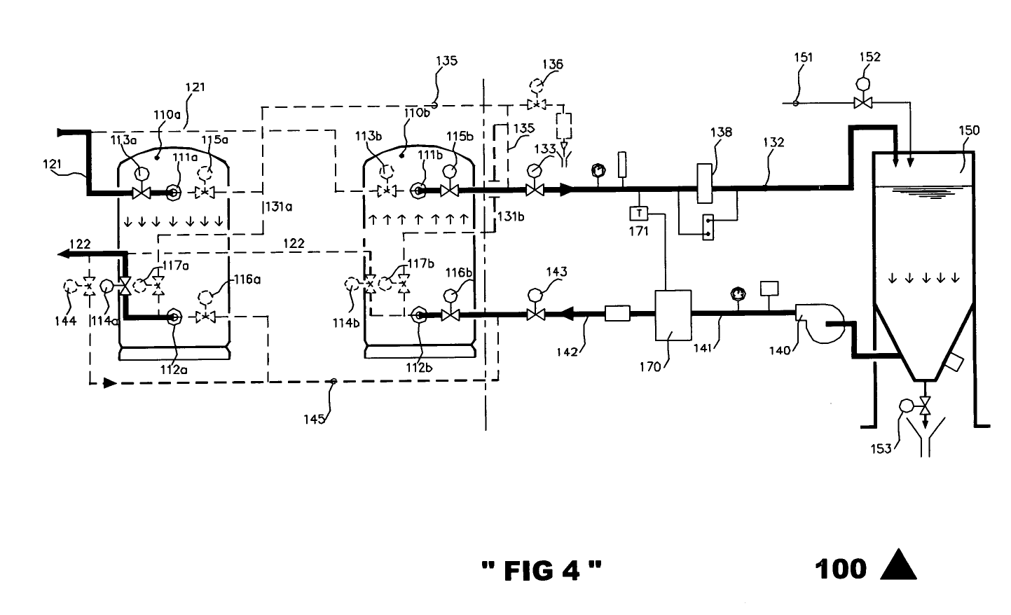

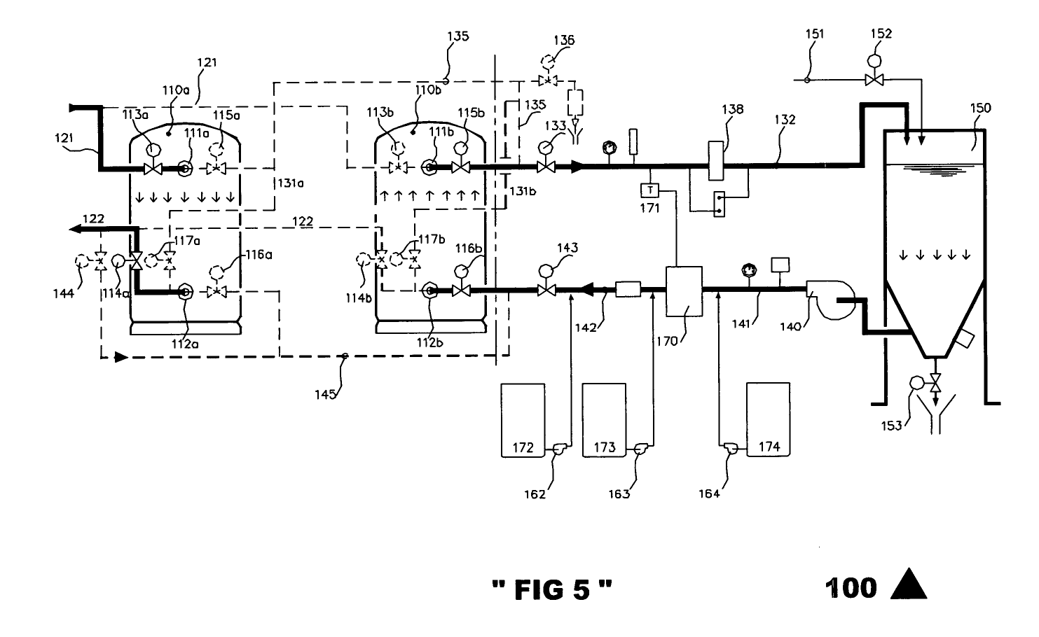

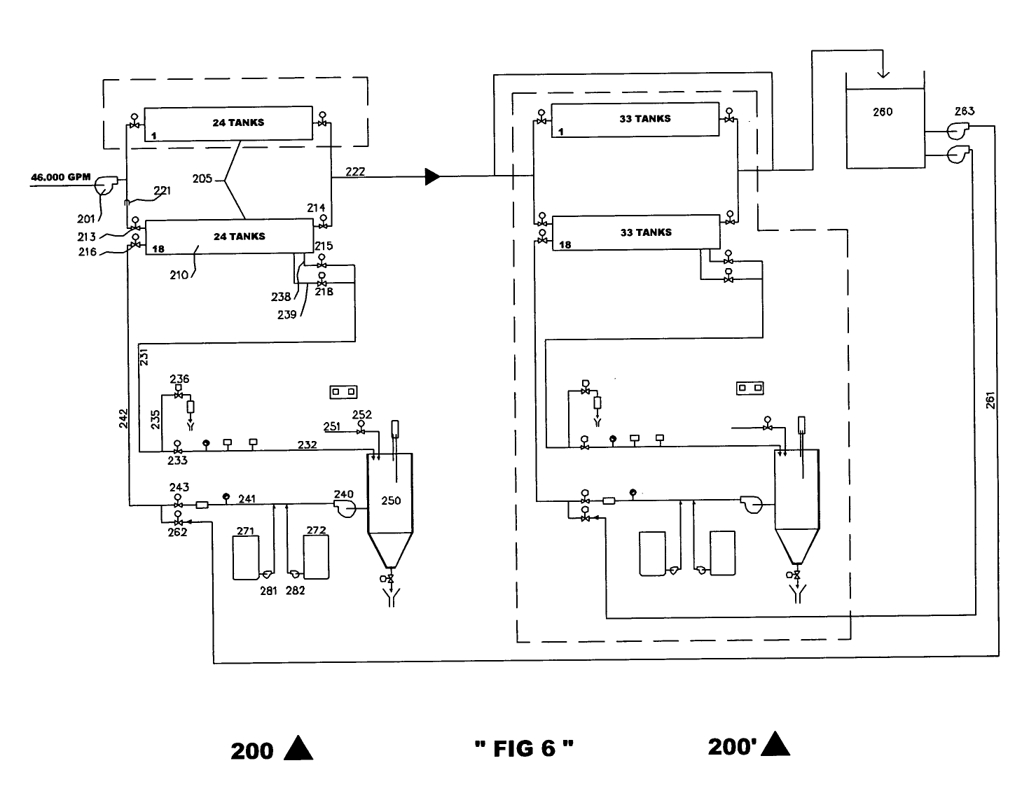

Now referring to FIG. 4, the first preferred embodiment of the cleaning/sterilizing system shown in FIG. 4 is done via the use of hot water. Other means to clean and/or sterilize the sand filter are possible as it will be shown further below in FIGS. 5 and 6.

To clean/sterilize sand filter 110b, cleaning water is first pumped from tank 150 using pump 140. The cleaning water is then heated to a predetermined temperature using heating means 170. The heat from the heating means 170 could come from electricity, natural gas and other known means for producing heat. The heated cleaning water is then forced in the outlet 112b of the filter 110b using pipes 141 and 142 and valves 143, and 116b.

While passing through the sand, the heated cleaning water kills and destroys all the bacteria which have grown over time and were not expelled by backwashing. Furthermore, the heat of the water helps to dissolve and wash away the polysaccharide and other organic materials which are present in the sand medium. The dead bacteria can then be easily dislodged from the sand and be washed away with the other unwanted particles. The heat of the cleaning water also helps dislodging oils and greases that could have accumulated in the sand.

The heated cleaning water then exits the filter 110b via its inlet 110b. From this point, the heated cleaning water, which is now loaded with dead bacteria and oils can be either drained away via valve 115b, draining pipes 135 and valve 136 or cycle into a closed sterilizing loop via valve 115b, valve 133, second bypassing pipes 132 and storage tank 150. In order to keep the hot cleaning water in circulation, the preferred method is to loop the cleaning water. However, to prevent the dislodged unwanted particles, bacteria, oils and even sand grains to cycle with the cleaning water, a filter 138 is preferably installed along bypassing pipe 132.

The temperature of the cleaning water is measured with temperature sensor 171, preferably installed along bypassing pipe 132. The temperature sensor 171 verifies that the cleaning water is hot enough to have biocidal properties and/or to dislodge oils and greases. The temperature sensor 171 is operatively connected to heating means 170 so that the heating means 170 can adjust the heat it provides.

Finally, it might be preferable to purge the storage tank 150 via valve 153 after a cleaning/sterilizing sequence in order to remove any unwanted particles, minerals, bacteria and/or oils that might still be present in the tank 150.

In a variant of the apparatus 100 shown in FIG. 5, the apparatus 100 is further equipped with chemical tanks 172, 173 and 174 connected to pipes 141/142 via pumps 162, 163 and 164 respectively. These tanks may contain oxidizers, chlorine or sodium hypochlorite, emulsifier, ozone, pH stabilizer, acids and other cleaning/sterilizing means. The chemical agents present in the cleaning water will help to dislodge the unwanted particles, minerals, bacteria and/or oils remaining in the sand. For example, citric acid will react with iron deposits and render them soluble in water. Chlorine and/or ozone will kill and destroy the bacteria present in the sand. Emulsifier will dissolve oils and/or greases. The cleaning water will then be able to remove and expel these remaining pollutants from the sand.

Understandably, even though three tanks and their respective pumps are shown, more or less tanks and pumps could be used depending upon the nature of the pollutants (metal deposits, bacteria, oils and greases, etc.).

Finally, it is also possible to add an ultra-violet light and/or an ultrasonic generator along pipes 141 and 142 to provide further biocidal properties. However, the skilled addressee will understand that these devices cannot be used alone.

Tankfiling mode

The storage tank 150 is generally filled by an external source of water via pipe 151 and valve 152. It is also possible that the pipe 151 be connected, via a pipe circuit (not shown), to the clean water pipe 122 so that the storage tank 150 is filled with a portion of the filtered water exiting the filters 110.

The skilled addressee will readily understand that the valves 113a, 113b, 114a, 114b, 115a, 115b, 116a, 116b, 117a, 117b, 133, 136 and 143 can be open and closed according to the different modes of operation of the apparatus. For instance, as shown in FIGS. 1 to 4, filter 110a can be in filtration mode while filter 110b is in another mode.

Now referring to FIG. 6, we can see another preferred embodiment of the present invention. In the embodiment of FIG. 6, we can see yet another possible apparatus for cleaning/sterilizing sand filters 210 using the invention.

As for the embodiment of FIGS. 1 to 4, this second apparatus 200 comprises sand filters 210 which, in this case, are provided in a plurality of clusters 205. Each cluster preferably comprises a plurality of filters 210. The number of clusters 205 and the number of filters 210 in each cluster 210 is chosen according to the desired and/or needed flow of filtered water. The apparatus 200 also comprises at least one storage tank 250 for storing cleaning water, cleaning and/or sterilizing means providers 271 and 272, a raw water pipe circuit 221, a clean water pipe circuit 222 and a cleaning/sterilizing pipe circuits 238, 231, 235, 232, 241 and 242. The apparatus 200 can also comprise a larger storage tank 260, for storing backwashing water, linked to a backwashing pipe circuit 261 and 242. The apparatus also comprises valves 213, 214, 215, 216, 218, 236, 233, 243 and 262 to control the flow of the water according to the different modes of operation of the apparatus 200. Each mode of operation will now be described in more details.

Filtration mode

As for the apparatus 100, the filtration mode is the normal mode of operation of the apparatus 200. In this mode, raw water enters the inlet (not shown) of each sand filters 210 via raw water pipes 221 and valve 213. A pump 201 may be preferably installed at the entry of the raw water in order to increase or regulate the pressure and the flow of the water. The raw water is then filtered by the sand in the sand filters 210 in manner known in the art. The filtered water then exits the filters 210 via their outlet (not shown) and it is then directed to a storage tank 260 via valves 214 and clean water pipes 222. It is to be understood that the filtered water could be directed to another stage of filtration 200′ (shown in dashed lines), to the water distribution network or to other locations if desired.

Backwashing mode

As explained before, in order to prevent the clogging of the sand filters 210, it is necessary to backwash them regularly. The backwash allows to remove at least a portion of the unwanted particles, minerals, bacteria and the like which have accumulated over time in the sand medium of the sand filters 210. To effectively backwash the filters 210, clean backwash water is first pumped from storage tank 260 through pump 263, pipe 261, valve 262, pipe 242, valve 216. The backwash water is then forced in the outlet (not shown) of the filters 210 to be backwashed. It is to be understood that it is also possible in the apparatus 200 to backwash one or a plurality of filter clusters 205 while the remaining clusters 205 are in other modes.

When the water is forced through the outlet of the filters 210, it removes and expels a portion of the unwanted particles, minerals and bacteria which are present in the sand of the filters 210. The water then exits the filters 210, via their inlet (not shown), dragging along the portion of unwanted particles, minerals and bacteria which the backwash water was able to remove. The backwash water is then preferably drained away via pipe 238, valve 215, pipe 231, pipe 235 and valve 236.

Rinsing mode

When a backwash cycle is completed, the sand medium contained in sand filters 210 may be unsettled. Moreover, a portion of the dislodged pollutants might still be present in the sand. Thus, it is preferable that a backwash cycle be followed by a rinse cycle.

In a rinse cycle, raw water is entering filter 210 via pipe 221, valve 213 and inlet (not shown). The raw water then goes through the sand of the sand filter 210, effectively dragging and compacting the sand medium to its normal filtering position. At the same time, the raw water will carry away at least a portion of the dislodged pollutants still present in the filter 210.

The water will then exit sand filter 210 via its outlet (not shown). However, since the sand of the sand filter 210 was not in its normal position, the filtered water might still carry pollutants. For this reason, filtered water exiting sand filter 210 in rinsing mode will be drained away instead of being sent through the clean water pipes. Hence, water exiting outlet (not shown) of filter 210 in rinsing mode will be directed toward the drain via pipe 239, valve 218, pipe 231, pipe 235 and valve 236.

After a predetermined amount of time, the filter 210 in rinsing mode will preferably automatically revert to the filtration mode. This will be done by closing valve 218 and opening valve 214.

Cleaning/Sterilizing mode

Understandably, the backwashing of the filters 210 does not remove all the unwanted particles, minerals, bacteria and/or oils contained in the sand. For this reason, it is necessary to regularly clean and/or sterilize the filters 210.

When in cleaning/sterilizing mode, cleaning water is pumped, via pump 240, from storage tank 250. Along the pipes 241, diverse chemical agents, stored in tanks 271 and 272, are added to the cleaning water. These chemical agents are generally but not exclusively acids (e.g. citric acid for removing iron deposits), oxidizers (e.g. chlorine, sodium hypochlorite and the like for disinfecting the sand), emulsifier for removing oils and greases and ozone for oxidizing organic and inorganic particles. These chemical agents can be added alone or in combination depending on the nature of the particles, minerals, bacteria and/or oils present in the sand. The cleaning water, now containing cleaning and/or sterilizing agents, is then sent to the filters outlet via valve 243, pipes 242 and valve 216.

The chemical agents present in the cleaning water help to dislodge the unwanted particles, minerals, bacteria and/or oils remaining in the sand. For example, citric acid will react with iron deposits and render them soluble in water. Chlorine and/or ozone will kill and destroy the bacteria present in the sand. Emulsifier will dissolve oils and/or greases. The cleaning water will then be able to remove and expel these remaining pollutants from the sand.

Water, now containing dislodged unwanted particles, minerals, bacteria and/or oils, will exit filters 210 via their inlet. From there, the water is either drained away via pipe 238 valve 215, pipe 231, pipe 235 and valve 236 or cycled in a cleaning/sterilizing loop via pipe 238, valve 215, pipe 231, valve 233 and pipe 232. A filter can be installed along pipe 232 if necessary. It is also possible to drain a first portion of the cleaning water and to cycle the remaining portion. For example, in the first minutes of the cleaning/sterilizing procedure, the water, containing the bulk of the dislodged unwanted particles, minerals, bacteria and/or oils could be drained away whereas for the remaining of the cleaning/sterilizing procedure, the water could be cycled.

The skilled addressee will understand that the decision to drain the cleaning water, to cycle it or to use a hybrid “draining and cycling” method is taken according to the level and types of pollutants located in the sand filters 210 and to the type of cleaning agent or agents used.

Finally, as for the apparatus 100, a purge of the storage tank 250 is preferable after a cleaning/sterilizing sequence to remove any unwanted particles, minerals, bacteria and/or oils that may still be present in the tank 250.

Tankfiling mode

As for the first embodiment 100, it is sometimes necessary to replenish the water tank 250 with clean filtered water. To do so, clean water is sent to the tank 250 via pipe 251 and valve 252. The pipe 251 can be connected to an external water source or to pipes 261 or 222 via a piping circuit (not shown).

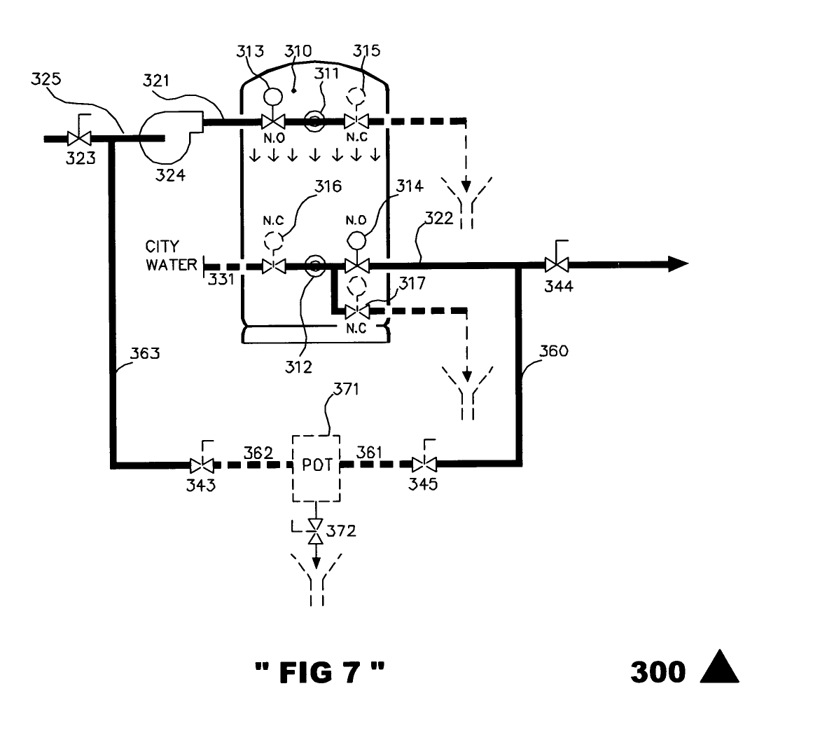

Now referring to FIGS. 7 to 10, we can see a third embodiment 300 of the present invention. In the first two apparatuses 100 and 200, the cleaning and/or sterilization of the filters 110/210 was done by backwashing the filter with water containing cleaning and/or sterilizing agent or agents.

However, in some occasions, it might be advantageous to clean a sand filter using raw water pipes instead of the backwashing pipes. Such an embodiment 300 is shown in FIGS. 7 to 10. This apparatus 300 comprises a sand filter 310 having an inlet 311 and an outlet 312. The apparatus 300 further comprises raw water pipes 325 and 321, backwashing pipe 331, clean water pipe 322 and cleaning pipes 360, 361, 362 and 363. The apparatus further comprises valves 313, 314, 315, 316, 317, 323, 343, 344, 345 for controlling the diverse flows of water. Finally, the apparatus 300 comprises a chemical bypass feeder 371 (i.e. pot feeder) for providing cleaning agent or agents to the cleaning water.

Similarly to the two previous embodiments 100 and 200, the apparatus 300 can work according to different modes of operation.

Filtration mode

FIG. 7 shows the apparatus 300 in filtering mode. This mode, as already understood, is the normal mode of operation of the apparatus 300. Raw water is pumped to the filter 310 via valve 323, pipe 325, pump 324, pipe 321, valve 313. The raw water then enters the filter 310 via its inlet 311.

The raw water is then filtered by the sand in the sand filters 310 in manner known in the art. Finally, the water, now filtered, exits the filter 310 through outlet 312. The filtered water is then sent toward it destination (i.e. a second filtration stage, a pool, an aqueduct, etc.) via valve 314, pipe 322 and valve 344.

Backwashing mode

When it is detected that the filtration efficiency of the filter 310 has descended below a certain threshold or in a periodic manner, the sand filter 310 is backwashed. The backwash allows to remove at least a portion of the unwanted particles, minerals, bacteria and the like which have accumulated over time in the sand medium of the sand filter 310.

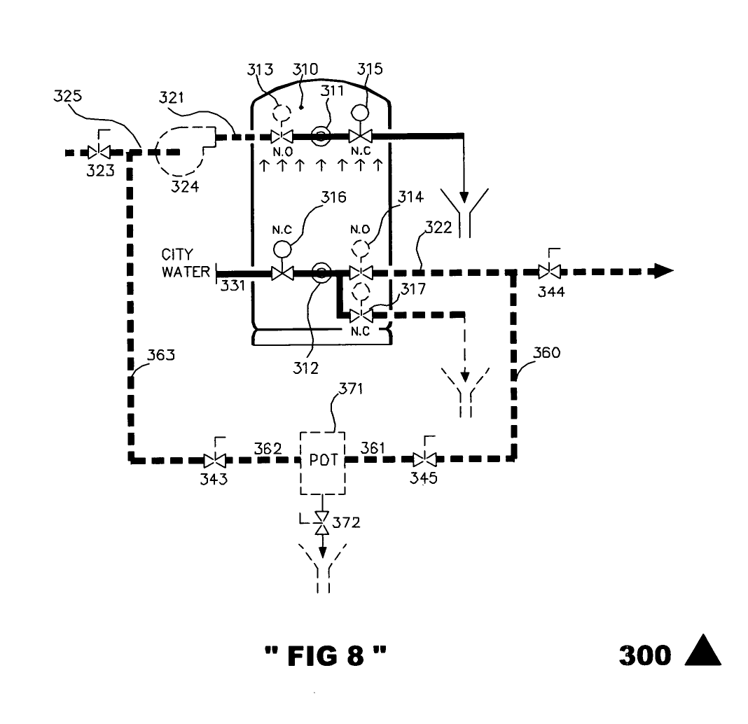

The backwashing mode is shown in FIG. 8. When in backwash mode, clean water, generally city water albeit other sources of clean water could be used, is forced through the outlet 312 of the filter 310 via pipe 331 and valve 316. Since, in backwashing mode, water goes through the filter 310 in the reverse direction of the normal flow of water, a portion of the unwanted particles, bacteria, oils and greases and other pollutants is effectively removed by the backwashing water and carried away. As the backwashing water exits the filter 310 through its inlet 311, the water, now carrying unwanted particles, bacteria, oil, grease and other pollutants, is drained away via valve 315.

Rinsing mode

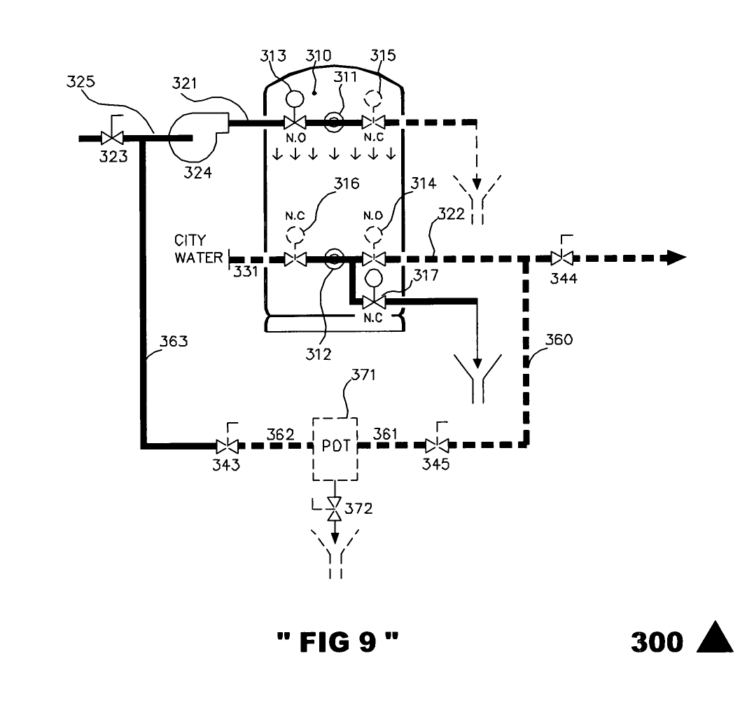

When the backwashing mode is over, it is preferable to rinse the apparatus 300 in order to remove pollutants which could still be remaining in the filter 310 and/or in the pipes. FIG. 9 shows this rinsing mode in more details.

To rinse the apparatus 300, first, valves 314 and 343 are closed and valves 323, 313 and 317 are opened. In this mode, raw water can enter filter 310 as in the filtration mode (i.e. via valve 323, pipe 325, pump 324, pipe 321, valve 313 and inlet 311). However, the filtered water which exits filter 310 via outlet 312 may contain pollutants which were still present in the valves, pipes and filter 310 from the backwashing cycle. Thus, the filtered water, exiting filter 310 via outlet 312, is sent to a drain via valve 317.

After a predetermined amount of time or when it is detected that the filtered water is now adequately filtered, the apparatus 300 reverts back to the filtration mode by closing valve 317 and opening valves 314 and 344.

Cleaning/Sterilizing mode

As for the apparatuses 100 and 200, backwashing sand filters does not remove all the unwanted particles, bacteria, oil, grease, metal deposits and other pollutants. Overtime, backwashing the filter 310 is not sufficient and the filter 310 needs to be cleaned and/or sterilized.

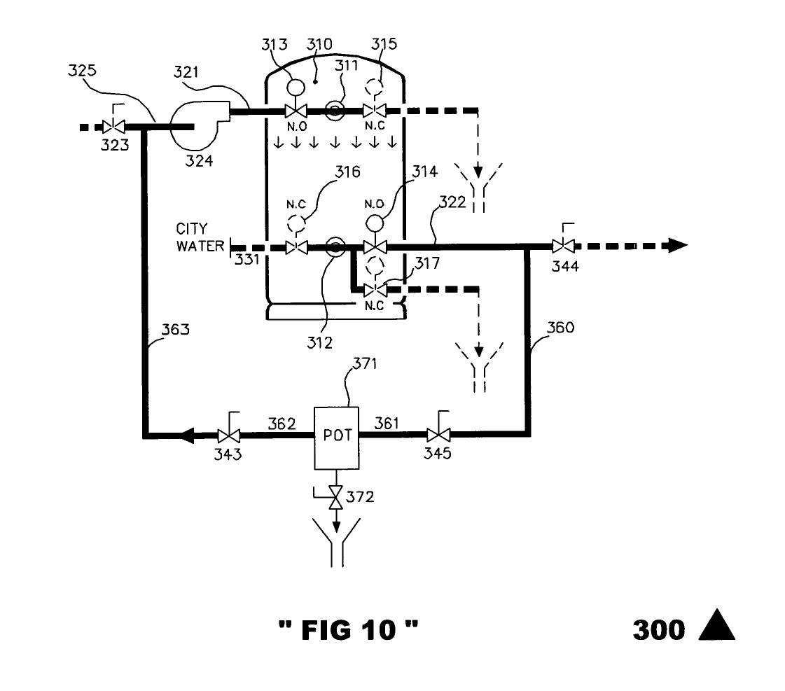

The cleaning/sterilizing mode of the apparatus 300, shown in FIG. 10, is conceptually similar but functionally different from the cleaning/sterilizing mode of apparatuses 100 and 200.

When in cleaning/sterilizing mode, valve 323 and 344 are closed. FIG. 10 shows manually actuated valves 323 and 344 but it is to be understood that automatic valves could be used without departing from the scope of the invention. Thus, the filtered water, exiting filter 310 is diverted, via pipe 360 and valve 345, to a chemical bypass feeder 371. The chemical bypass feeder 371 is generally filled manually with cleaning and/or sterilizing agent. The agent, contained in the chemical bypass feeder 371, mixes with the filtered water. The cleaning and/or sterilizing agent bearing water is then sent to the inlet 311 of the filter 310 via pipe 362, valve 343, pipe 363, pipe 325, pump 324, pipe 321 and valve 313. The water containing the cleaning and/or sterilizing agent then flows through the sand contained in the filter 310. The cleaning agent used will depend upon the types of pollutants present in the sand. When a chemical bypass feeder 371 is used, the agent preferably comes in liquid or solid form. However, should another type of agent provider be installed (i.e. reservoir 172 and following, heater 170, etc.), the agent could be provided in other form. Here, contrary to the apparatuses 100 and 200, the cleaning agent bearing water flows through the filter 310 in the same direction as the normal flow of water (i.e. as in filtration mode). In the apparatuses 100 and 200, the cleaning agent bearing water flows in the sand filter in the reverse direction (i.e. as in backwashing mode).

When the cleaning water exits the filter 310, through outlet 312, the water, now containing unwanted particles, bacteria, oil/grease, metal deposits and/or other pollutants, can be either drained away via valve 317 or preferably be cycled back to the chemical bypass feeder 371 via valve 314, pipe 322, pipe 360, valve 345 and pipe 361. As the cleaning water is cycled, cleaning and/or sterilizing agent could be manually added to the chemical bypass feeder 371 to keep the cleaning agent level at an adequate level. A small filter (not shown) could be added along pipe 361 to prevent excessive pollutants to be cycled back to the chemical bypass feeder 371.

Even though the apparatus 300 is shown to be working primarily manually, it is to be understood that all manually actuated equipments (chemical bypass feeder 371, valves 323, 344, 345, 343 and 372, etc.) could be replaced by automatically operated equipments without departing from the scope of the invention.

When the cleaning/sterilizing mode is over, it is preferable to rinse the apparatus 300 and to purge the chemical bypass feeder 371 since cleaning and/or sterilizing agent and/or pollutants might still be present in filter 310 and several pipes.

First, valves 343 and 314 are closed then valves 317 and 323 are opened. Raw water will then be able to enter filter 310 via valve 323, pipe 325, pump 324, pipe 321, valve 313 and inlet 311. As water exits filter 310 via outlet 312, it might still be carrying residues of cleaning are/or sterilizing agent. The water is thus drained away via valve 317.

After a predetermined amount of time, valve 317 is closed and valves 314, 345 and 372 are opened. The water which exits filter 310 via outlet 312 is thus directed toward the chemical bypass feeder 371 via valve 314, pipe 322, pipe 360, valve 345 and pipe 361. However, since valve 372 leads to a drain, the water, which is possibly still carrying residues of cleaning are/or sterilizing agent will be effectively drained away. This portion of the procedure will also effectively rinse filter 310, valve 314, pipe 322, pipe 360 and pipe 361. At the same time, the content of the chemical bypass feeder 371 will be purged and also drained away.

Then, after another predetermined amount of time, valves 313 and 345 are closed and valve 343 is opened. Raw water will then be directed directly toward the chemical bypass feeder 371 via valve 323, pipe 325, pipe 363, valve 343 and pipe 362. The raw water will therefore rinse pipe 325, pipe 363, valve 343 and pipe 362 as it goes toward the drain via valve 372.

Finally, after still another predetermined amount of time, the apparatus 300 will revert back to the filtration mode by closing valve 343 and opening valves 313, 314 and 344.

The skilled addressee will note that if the rinsing valve 317 is absent (some filtration systems do not comprise a rinsing valve 317), the rinsing of the filter 310 after a cleaning/sterilizing cycle can be done by closing valves 313 and 314 and opening valves 316 and 315 and by backwashing the filter 310 with preferably city water.

It is to be understood that, as in the description of the apparatuses 100 and 200, in the preceding description, valves not mentioned during a given mode are presumably closed unless otherwise specified. Also, as for the apparatuses 100 and 200, all the valves of apparatus 300 can be open and closed according to the different modes of operations of the apparatus.

In apparatuses 100 and 200, all the valves and pumps are preferably electromechanically controlled via a central control station (not shown). This central control station is also preferably linked to all the sensors (pH, pressure, oxidation reduction potential, temperature, etc.) located along the pipes of the apparatuses. The central control station can be programmed to initiate backwashing or cleaning/sterilizing cycles for one or a plurality of filters on regular intervals or when the quality of the filtered water descends below a predetermined threshold. The central control station also controls the distribution of the chemical agents. The apparatuses 100 and 200 are thus preferably entirely automatic.

As for apparatus 300, since it refers generally to a single filter installation, some valves may be manually actuated while other electromechanically actuated. However, apparatus 300 could also be completely automated without departing from the scope of the invention. Also, apparatus 300 could obviously comprises all the necessary sensors.

It is worth noting to mention that the length and frequency of the backwash and cleaning/sterilizing cycles depend on the nature of the raw water, the type of filters and the type of pollutants. Indeed, highly polluted raw water will tend to clog filters faster then lightly polluted water. Therefore, an apparatus which filters highly polluted water will require more backwash and cleaning/sterilizing cycles than an apparatus filtering lightly polluted water.

The skilled addressee will also readily understand that other components such as sensors (pH, temperature, pressure, oxidation reduction potential and the like), sight glasses, pumps and valves can be added to the apparatuses 100, 200 and 300, when and if needed, along the pipes, in order to measure water characteristics, increase or regulate pressure, provide visual inspection or control the flow of water.

Moreover, the apparatuses 100, 200 and 300 can be used alone or in combination with other apparatuses 100, 200 and 300 and/or other filtration systems (i.e. reverse osmosis filters).

Although preferred embodiments of the invention have been described in detail herein and illustrated in the accompanying figures, it is to be understood that the invention is not limited to these precise embodiments and that various changes and modifications may be effected therein without departing from the scope or spirit of the present invention.

1. A sand filter cleaning apparatus comprising:
a) at least one sand filter having an inlet and an outlet, said inlet being fluidly connected to a raw water pipe circuit and said outlet being connected to a filtered water pipe circuit;
b) a cleaning water pipe circuit fluidly connected to said inlet and said outlet of said at least one sand filter;
c) at least one cleaning means provider for providing at least one cleaning agent, said cleaning agent provider being connected to said cleaning water pipe circuit;
d) a cleaning water source for providing cleaning water, said cleaning water source being connected to said cleaning water pipe circuit;
whereby the cleaning of said filter is effected by circulating said cleaning water in said filter, using said cleaning water pipe circuit, wherein said cleaning water contains said at least one cleaning agent.

2. A sand filter cleaning apparatus as claimed in claim 1 wherein said cleaning water enters said filter via said inlet and exits said filter via said outlet.

3. A sand filter cleaning apparatus as claimed in claim 1 wherein said cleaning water enters said filter via said outlet and exits said filter via said inlet.

4. A sand filter cleaning apparatus as claimed in claim 1 wherein said cleaning agent is heat and wherein said cleaning means provider is a water heater.

5. A sand filter cleaning apparatus as claimed in claim 1 wherein said cleaning agent is an oxidizer.

6. A sand filter cleaning apparatus as claimed in claim 5 wherein said cleaning agent is chlorine, bromine or sodium hypochlorite.

7. A sand filter cleaning apparatus as claimed in claim 5 wherein said cleaning agent is ozone.

8. A sand filter cleaning apparatus as claimed in claim 1 wherein said cleaning agent is an emulsifier.

9. A sand filter cleaning apparatus as claimed in claim 1 wherein said cleaning agent is an acid.

10. A sand filter cleaning apparatus as claimed in claim 9 wherein said acid is citric acid.

11. A sand filter cleaning apparatus as claimed in claim 1 further comprising a central control station and whereby said apparatus is fully automated.

12. A sand filter cleaning apparatus as claimed in claim 1 further comprising a plurality of cleaning means providers for providing a plurality of cleaning agents.

13. A sand filter cleaning apparatus as claimed in claim 1 further comprising at least another sand filter and wherein a portion of said clean water source comes from said at least another sand filter.

14. A method for cleaning at least one sand filter, said method comprising the steps of:
a) providing cleaning water;
b) providing at least one cleaning agent;
c) adding said at least one cleaning agent to said cleaning water;
d) circulating said cleaning water in said filter wherein cleaning water contains said at least one cleaning agent.

15. A method as claimed in claim 14 wherein said cleaning agent is heat.

16. A method as claimed in claim 14 wherein said cleaning agent is an oxidizer.

17. A method as claimed in claim 16 wherein said cleaning agent is chlorine, bromine or sodium hypochlorite.

18. A method as claimed in claim 16 wherein said cleaning agent is ozone.

19. A method as claimed in claim 14 wherein said cleaning agent is an emulsifier.

20. A method as claimed in claim 14 wherein said cleaning agent is an acid.

21. A method for cleaning at least one sand filter, said method comprising the steps of:
a) providing backwashing water;
b) backwashing said filter with said backwashing water;
c) draining away said backwashing water;
d) providing cleaning water;
e) providing a least one cleaning agent;
f) adding said a least one cleaning agent to said cleaning water;
g) circulating said cleaning water in said filter wherein said cleaning water contains said a least one cleaning agent.

22. A method according to claim 21, further comprising the step of:
h) recirculating said cleaning water containing said a least one cleaning agent for a predetermined amount of time.

23. A method according to claim 21, further comprising the step of:
h) draining away said cleaning water containing said a least one cleaning agent.

24. A method according to claim 21, further comprising the step of:
h) draining away said cleaning water containing said a least one cleaning agent for a first predetermined amount of time;
i) recirculating said cleaning water containing said a least one cleaning agent for a second predetermined amount of time after said first predetermined amount of time.
